(19) United States
(12) Patent Application Publication
(10) Pub. No.: US 2011/0018483 A1
(43) Pub. Date: Jan. 27, 2011

(54) STATOR END-WINDING COMPONENT MONITORING SYSTEM

(75) Inventors: Glen Peter Koste, Niskayuna, NY (US); Axel Busboom, Unterleinleiter (DE); Christopher Anthony Kaminski, Niskayuna, NY (US); Hua Xia, Altamont, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/506,287

(22) Filed: Jul. 21, 2009

(51) Int. Cl. H02H 7/06

(52) U.S. Cl. 318/490

(57) ABSTRACT

A stator comprises stator end-winding components and a sensing cable. The sensing cable comprises two fixation points secured to two of the end-winding components, and sensors to measure a relative displacement between two or more of the stator end-winding components.

### BACKGROUND

The invention relates generally to sensing technology and more particularly to a sensing system for health monitoring of end-winding components of a rotating machine such as a generator or motor.

Rotating machines such as electric generators driven by steam turbines or gas turbines have the capacity to carry several thousand amperes of current in their stator windings. Stator windings generally comprise conductive bars secured in corresponding slots in a stator core and end windings extending beyond the stator core. End-winding components are subject to electro-dynamic and mechanical forces that induce a displacement of the end windings. Electro-dynamic forces are induced, for example, by large current passing through the end windings during starting and peak load conditions. Mechanical forces are caused by normal mechanical vibrations of the rotating machine. It has been recognized that an excessive displacement of the end windings has several undesirable effects including that the winding insulation in the end windings may be destroyed, and end windings may suffer from wear due to electromechanical forces which lead to premature failure of the rotating machine. There is a need in the art to monitor the end winding status, and an early and accurate detection of end winding loosening is desirable.

One end winding loosening detection technique utilizes fiber-optic accelerometers for monitoring the winding health. Fiber-optic accelerometers typically measure accelerations in three perpendicular axes at several locations on the end windings. However, such a method requires that each axis or pair of axes have a separate accelerometer and cable routed in and out, which results in a bulky wiring package. Additionally, accelerometers measure vibration with respect to a stationary reference frame, such as the floor to which the rotating machine is mounted. The measured vibration is the sum of vibrations from multiple potential sources, including rotor imbalance, bearing spall, and end-winding component degradation. Therefore, acceleration measurements are an indirect measure of end winding health.

It would be desirable to have an improved sensing device for end winding displacement measurement.

### BRIEF DESCRIPTION

In accordance with an embodiment, a stator comprises stator end-winding components and a sensing cable. The sensing cable comprises two fixation points secured to two of the end-winding components, and sensors to measure a relative displacement between the two of the stator end-winding components.

In accordance with another embodiment disclosed herein, a stator end winding and connection ring monitoring system comprises a fiber optic sensing cable. The fiber optic sensing cable comprises sensors each secured by fixation points between two of the connection rings. The stator end winding and connection ring monitoring system further comprises a light source for supplying light to the sensors, a light detector for receiving light that has passed through or has been reflected from the sensors, and a processor for receiving signals indicative of the detected light from the light detector and for using the signals for determining whether a relative displacement between any of the connection rings is outside an acceptable range.

### DRAWINGS

These and other features, aspects, and advantages of the present invention will become better understood when the following detailed description is read with reference to the accompanying drawings in which like characters represent like parts throughout the drawings, wherein:

FIG. 1 is a simplified cross-sectional view of a rotating machine comprising a rotor and a stator.

FIG. 2 is an enlarged view of portion A in FIG. 1.

FIG. 3 is an illustrative perspective view of an end region of the stator with a plurality of connection rings mounted to a front end of the stator.

FIG. 4 is an enlarged cross-sectional view of a fiber sensing cable according to one embodiment of the invention.

FIG. 5 is an enlarged cross-sectional view of the fiber sensing cable according to another embodiment of the invention.

FIG. 6 is a partial enlarged top view of a sensing cable mounted on three end-winding components according to one embodiment of the invention.

FIG. 7 is an exemplary wavelength spectrum of a plurality of Bragg gratings.

FIG. 8 is a partial top view of a sensing cable mounted on the end-winding components according to another embodiment of the invention.

FIG. 9 is a partial top view of a sensing cable mounted on the end-winding components according to still another embodiment of the invention.

FIG. 10 is a partial top view of a sensing cable mounted on the end-winding components according to still another embodiment of the invention.

FIG. 11 is a partial top view of a sensing cable mounted on the end-winding components according to still another embodiment of the invention.

FIG. 12 is a partial side view of a semi-rigid tie and sensing cable mounted on the end-winding components according to still another embodiment of the invention.

### DETAILED DESCRIPTION

Embodiments of the invention are related to stator end winding monitoring systems using fiber optic sensing cables for measuring relative displacement of end-winding components, including but not limited to supporting or connecting components directly or indirectly supporting or connecting with stator end windings including but not limited to connection rings and stator bars. Relative displacement between end-winding components is an indication of stator end winding status. “Relative displacement” herein after refers to a shift of a distance between two end-winding components. The two end-winding components may be directly adjacent to each other, or may be separated by one or more end-winding components there between. As used herein the terms “a,” “an,” and “the” do not denote a limitation of quantity, but rather denote the presence of at least one of the referenced items. Similarly, as used herein “two end-winding components” means at least two end-winding components.

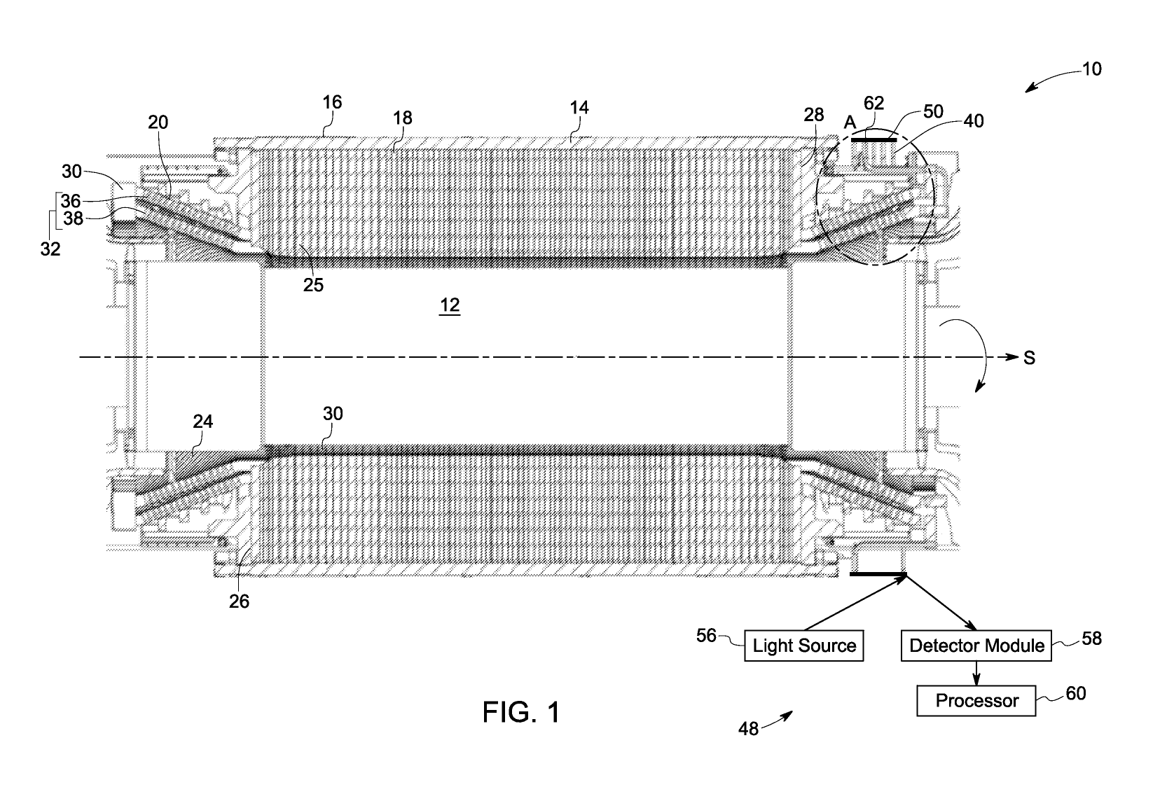

With reference to FIG. 1, a rotating machine 10 such as an AC induction motor, AC generator, AC synchronous motor or AC synchronous generator is shown. In one embodiment, the rotating machine 10 is a hydrogen-cooled generator and comprises a rotor 12 and a stator 14. Stator 14 comprises a frame 16, a stator core 18 mounted in a fixed position within frame 16, and a plurality of stator windings 20 wound on stator core 18. In one embodiment, stator core 18 is made from laminations of a ferromagnetic material such as iron, cobalt, nickel, or an alloy thereof. Stator core 18 may comprise a stator end winding 24 extending through front and rear ends 26, 28 of stator core 18. Stator core 18 defines a plurality of slots 25 in an inner surface of stator core 18 for receiving at least portions of the stator windings 20.

In the embodiment of FIG. 1, rotor 12 is rotatably located in the rotor end bell 24 of stator 14 and electromagnetically coupled with stator 14. A longitudinal rotating axis of rotor 12 is coincident with a longitudinal axis S of the stator core 18. An annular gap 30 between rotor 12 and stator 14 is defined by an outer surface of rotor 12 and the inner surface of stator core 18. In operation of a rotating machine 10, for example, a current is passed through the stator windings 20, thereby creating a magnetic field in rotor end bell 24, which is intensified by the ferromagnetic material in stator core 18. The magnetic field couples with conductors of rotor 12 to produce a torque which turns the rotor 12. In one example of operation of a generator (rotating machine 10), steam is used to drive rotation of rotor 12 which cases a magnetic field in the rotor end bell 24 that induces alternating current in the stator windings 20.

Stator windings 20 each comprise conductive bars 32 secured in the corresponding slot 25 and extending beyond front and rear ends 26, 28 of stator core 18 and a loop 34 at a distal end of the conductive bars 32. As used herein after, loops 34 along with the conductive bar portions extending out of the stator core 18 are referred to as the “end windings.”

Loops 34 are each electrically connected to corresponding conductive bars 32 in any suitable manner. In the illustrated embodiment of FIG. 1, conductive bars 32 comprise top and bottom bars 36, 38 arranged in two layers and secured in a respective slot 25. Each loop 34 electrically connects a corresponding set of top and bottom bars 36, 38. In one embodiment, the stator windings 20 comprise three groups for three-phase (U-phase, Y-phase and W-phase) alternating current output.

In the illustrated embodiment of FIG. 1, stator 14 comprises a plurality of connection rings 40 mounted to front and rear ends 26, 28 of the stator core 18. In one embodiment, connection rings 40 are parallel to each other and are each substantially perpendicular to the longitudinal axis (S). In one embodiment, stator 14 comprises three pairs of connection rings 40 mounted to rear end 28 of stator core 18. Each pair of connection rings 40 is connected to one phase group of the stator windings 20.

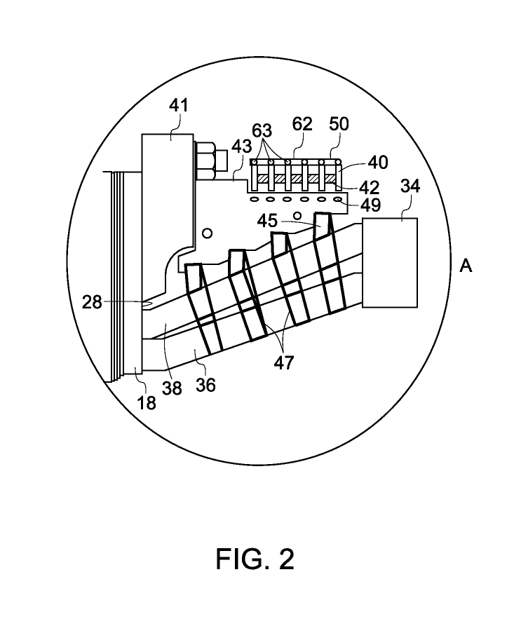

With reference to FIG. 2, every two neighboring connection rings 40 are spaced apart from each other along the longitudinal axis (S) by a respective one of a plurality of connection ring spacers 42. In one embodiment, stator 14 further comprises an annular core end flange 41 mounted to rear end 28. A plurality of axial supports 43 are secured to the annular core end flange 41 along an outer peripheral of core end flange 41. Each axial support 43 has an inclined lower edge with a plurality of holes (not shown). A plurality of ties 47 are used to lash top and bottom conductive bars 36, 38 together and to the holes of axial supports 43. Binding bonds 45 are provided between top and bottom conductive bars 36, 38, and between top bars 36 and corresponding axial support 43. Each axial support 43 may further comprise a plurality of holes 49 in an upper portion thereof. Connection rings 40 are lashed to holes 49 by ties (not shown) and secured to the axial supports 43. End winding and connection ring securing arrangements in FIG. 2 are provided for purposes of example. Another embodiment, for example, includes use of a compressible pad to secure end winding turns such as shown in U.S. Pat. No. 3,924,149, to Estrada et al., entitled TIELESS BRACING AND METHOD FOR SUPPORTING END TURNS OF A DYNAMOELECTRIC MACHINE, is hereby incorporated in its entirety by reference.

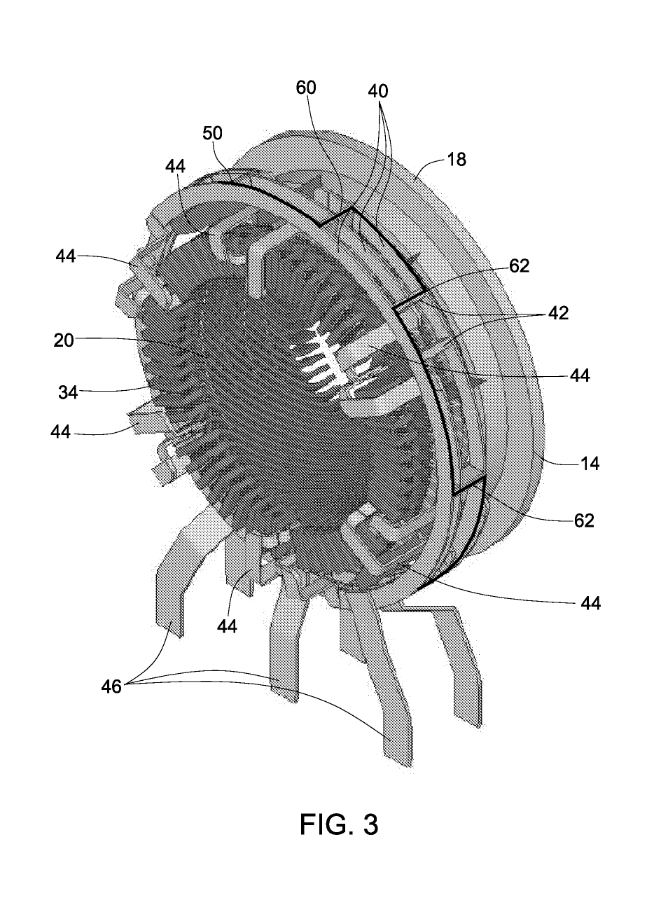

With reference to FIG. 3, in one embodiment, stator 14 further comprises a plurality of interconnection conductors 44 for interconnecting each group of stator windings 20 to the corresponding connection ring 40. In one embodiment, stator 14 further comprises a plurality of terminals 46 for connecting the three-phase connection rings 40 to an external electronic device (not shown). In one embodiment, each interconnection conductor 44 and terminal 46 comprise an integral portion of a corresponding connection ring 40. In another embodiment, interconnection conductors 44 and/or terminals 46 may comprise a discrete member connected to the connection rings 40 by a brazing process, for example.

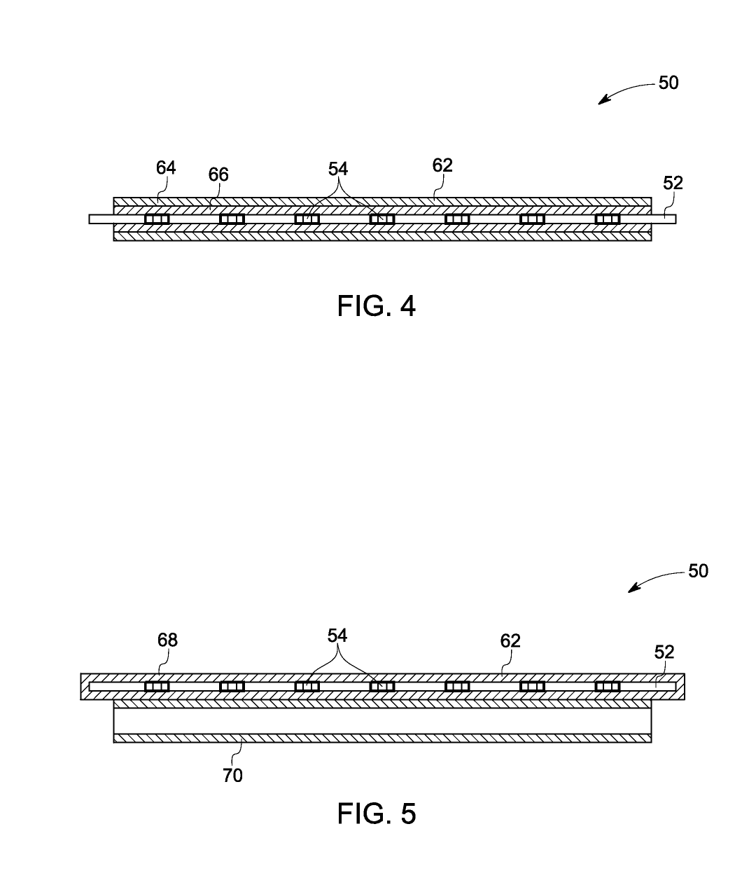

With reference to FIG. 1, in one embodiment, stator 14 further comprises a sensing system 48 for monitoring the end winding condition of stator 14. In one embodiment, sensing system 48 comprises a sensing cable 50 and a plurality of sensors secured in the sensing cable 50. In one embodiment, sensors comprise fiber sensors each including an optical fiber 52 (FIG. 4). In a more specific embodiment, the optical fibers each further comprise a plurality of Bragg gratings 54 (FIG. 4) inscribed thereon. Sensing system 48 further comprises a light source 56 for transmitting light to the optical fibers, and a detector module 58 for detecting light transmitted or reflected from the optical fiber 52 (FIG. 4) and for monitoring wavelength changes of the detected light. In one embodiment, the sensing system further comprises a processor 60 for receiving wavelength changes from detector module 58 and for performing calculations to be used for condition monitoring, machine protection, maintenance scheduling, or control of the rotating machine 10.

In certain embodiments of the invention, sensing cable 50 is mounted to end-winding components to measure a relative displacement of at least two end-winding components so as to monitor status of the end windings. End-winding components in certain embodiments of the invention comprise the end windings themselves as well as all components directly or indirectly supporting or connecting with the stator winding 20. For example, end-winding components may comprise, end windings, connection rings 40, loops 34, core end flange 41, connection ring spacers 42, axial supports 43, interconnection conductors 44, and terminals 46. In the illustrated embodiment, sensing cable 50 is mounted between two connection rings 40 to measure a relative displacement of the two connection rings 40. In other embodiments, sensing cable 50 is mounted on other end-winding components that are directly or indirectly supporting or connecting with the end windings. In one embodiment (not shown), for example, sensing cable 50 is mounted on at least one of the connection rings 40 and the core end flange 41 to measure a relative displacement of the at least one connection rings 40 and the core end flange 41. In another embodiment (not shown), the sensing cable 50 may be mounted on loops 34 to measure a relative displacement of at least two loops 34.

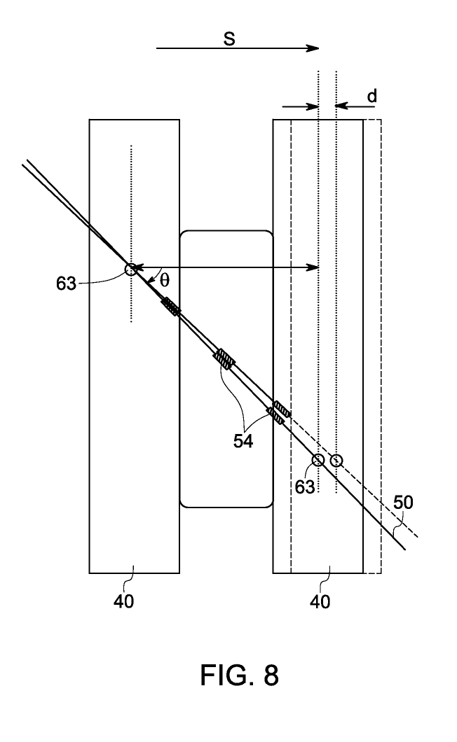

As can be seen more clearly in FIG. 2, in one embodiment, sensing cable 50 may comprise one cable integrating a plurality of measurement portions 62 that each cross at least two end-winding components (at least two parallel connection rings 40 in the illustrated embodiment). In another embodiment, sensing cable 50 may comprise a plurality of separate measurement portions 62 each across at least two end-winding components. The measurement portions 62 each comprise at least two fixation points 63 respectively secured to at least two components (shown as connection rings 40 in FIG. 2), and a plurality of sensors 54, such as fiber Bragg gratings 54 shown in FIG. 8 between fixation points 63. Wavelength changes of the sensors between two neighboring fixation points 63 are indications of a relative displacement of the two parallel connection rings 40. In one embodiment, measurement portion 62 is arranged to be adjacent to one interconnection conductor 44 (FIG. 3).

FIG. 4 is a partial cross-sectional view of an exemplary measurement portion 62 of sensing cable 50 according to one embodiment. The exemplary measurement portion 62 comprises a plurality of fiber sensors (shown as Bragg gratings) 54 inscribed in optical fiber 52 which is sealed in a sheath tube 64 by filling a polymeric adhesive material around the optical fiber 52. In certain embodiments, sheath tube 64 comprises a composite tube including fiberglass for example, or a polymeric tube including a material, such as, polyimide, polytetrafluoroethylene, silicone, or elastomer. Accordingly, the sensing cable 50 is capable of sustaining a large deformation without rupture under stress, and can recover to an original dimension after removal of the stress. In one embodiment, a packaging process of the sensing cable 50 comprises a curing process to turn an aqueous polymer adhesive material 66 into solid under temperature of 150-200° C., so as to integrate the optical fiber 52 and the Bragg gratings 54 in the sheath tube 64. In certain embodiments, sensing cable 50 is secured to the end-winding components by either a glue or other bonding material.

FIG. 5 is a cross-sectional view of an exemplary measurement portion 62 of sensing cable 50 according to another embodiment. The illustrated measurement portion 62 comprises a coating layer 68 surrounding the optical fiber 52, and a supporting tube 70 supporting the optical fiber 52. The coating layer 68 may comprise polyimide material and has a thickness ranging from 20 to 50 micrometers. The coating layer 68 and the optical fiber 52 protected by the coating layer 68 are attached to an outer surface of the supporting tube 70 by an adhesive material, for example. In certain embodiments, supporting tube 70 comprises fiberglass, flexible plastic, or insulation material. The supporting tube 70 is mounted between two end-winding components by adhesive material and/or a clamp, for example. Displacements of end windings are transferred to supporting tube 70 and further induce deformation or bending of the optical fiber 52 which may be detected from wavelength shifts of the fiber sensors 54.

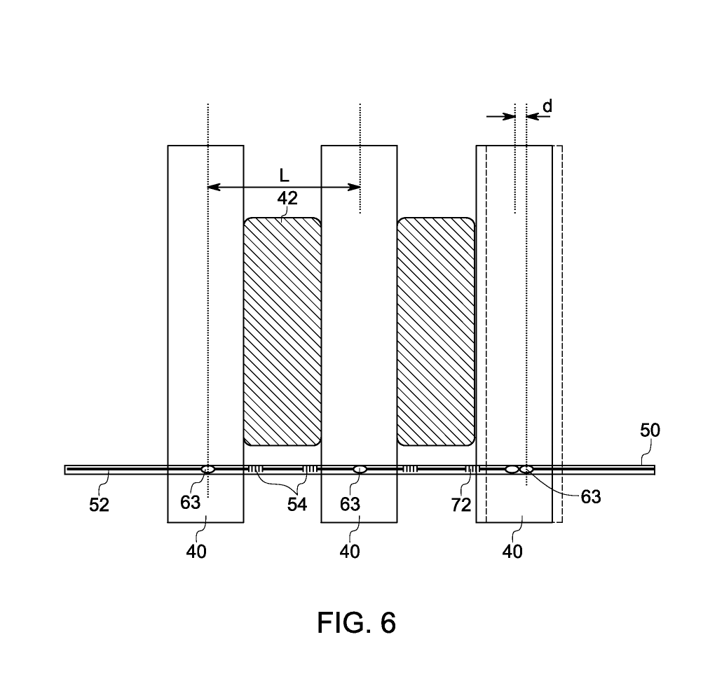

FIGS. 6 and 8-12 illustrate enlarged cross-sectional views of measurement portions 72, 74, 76, 78, 80, 82 of sensing cables 50 for measurement of relative displacements of end-winding components according to different embodiments of the invention. The end-winding components are connection rings 40 in the illustrated embodiments, but could be replaced by any other end-winding components.

With reference to FIG. 6, an embodiment 72 of the measurement portion for measurement of relative displacements of three connection rings 40 comprises fixation points 63, each secured to a corresponding connection ring 40, and one or more Bragg gratings 54 between every two adjacent fixation points 63 (connection rings 40). In the illustrated embodiment, the sensing cable 50 is oriented to be perpendicular to the connection rings 40. In one embodiment, the fixation points 63 are secured to the connection rings 40 by an adhesive material such as epoxy.

When light from light source 56 is transmitted through optical fiber 52 to Bragg gratings 54, light energy is reflected by the number (i) Bragg gratings 54 at corresponding Bragg wavelengths λ_{B}(i) given by equation 1:

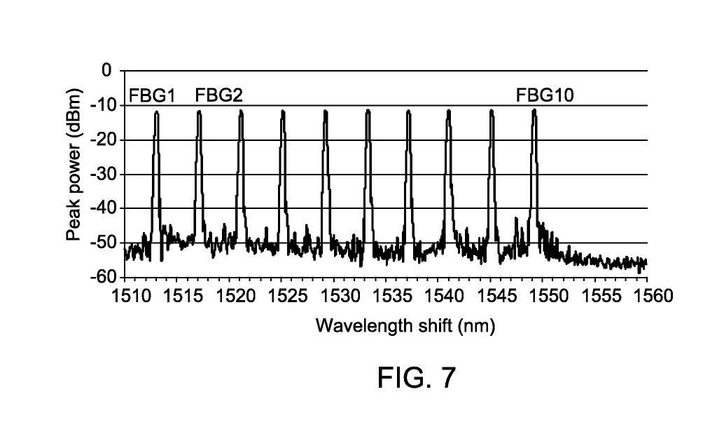

λ_{B}(i)=2n_{eff}Λ(i), equation 1

wherein “n_{eff}” is effective refractive index of the fiber core, and “Λ(i)” is the periodicity of the corresponding number (i) grating modulation structure. In certain embodiments, different Bragg gratings 54 have different modulation periods, and thus Bragg gratings 54 have different central wavelengths as is illustrated in FIG. 7. Accordingly, detector module 44 can differentiate the spectrums respectively reflected from Bragg gratings 54. It is thus beneficial to arrange more measurement points (Bragg gratings) on the same sensing cable 50 without the need for additional wirings.

The effective index of refraction (n_{eff}) and the periods (Λ(i)) of the corresponding Bragg gratings are both functions of temperatures and strains applied to the Bragg gratings 54. Wavelength change is thus induced by both thermal and strain dynamics within a certain time period (t) according to equation 2:

Δλ_{B}(T,t)=K_{ε}ε(T,t)+K_{T}ΔT(t) equation 2

wherein K_{ε} and K_{T} are respectively strain and temperature sensitivities of the Bragg gratings 54. In some applications, dynamic events such as loosening events may occur at a much higher frequency and occur much more quickly than temperature changes. Accordingly, separation between the slow varied thermal response induced by environmental temperature changes and the transient dynamic response can be accomplished by analyzing wavelength shifts within certain time intervals, such that the temperature variation could be ignored. For example, standard deviation or root means square (RMS) of the wavelength shifts of the Bragg grating represents dynamic strain that is associated with displacement of the connection rings.

Frequency domain techniques, such as fast Fourier transforms, wavelet analysis, and spectral analysis are well suited for separating (slow) thermal response from (fast) strain response for machines and generators due to the periodic nature of the currents and forces introduced thereby. In certain embodiments, for generators, end winding displacements due to strain are most likely to occur at twice the fundamental frequency of the generators, i.e. at 120 Hz for generators with a fundamental frequency of 60 Hz, or at 100 Hz for 50 Hz generators. The displacement measurement of connection rings 40 is thus relatively independent of environment temperature change.

During measurements, with reference to FIG. 6, a displacement (d) of one connection ring 40 causes wavelength shifts of Bragg gratings 54 between the connection ring 40 and a neighboring connection ring 40. The displacement (d) can thus be monitored by wavelength shifts of the Bragg gratings 54 between the two neighboring connection rings 40. Signal processing, feature extraction, and classification methods would be used to infer whether the observed displacements are acceptable or not. This would include specifically looking for spectral components at 120/100 Hz and higher harmonics. A controller (not shown) may take action when the threshold is exceeded. The “controller” may alternatively be a SCADA system, machine protection system, or monitoring system. In the illustrated embodiment, the sensing cable 50 is tightened between every two neighboring fixation points 63.

In certain embodiments, a maximum relative displacement (dₘₐₓ) between end-winding components is a displacement length that one sensing cable 50 can measure and is related to a maximum strain (εₘₐₓ) that the sensing cable 50 can sustain. The sensing cable 50 may be broken or sheared when an excessive displacement larger than the maximum displacement occurs. The strain (ε) on the sensing cable 50 is according to equation 3:

ε(t)=d/L equation 3

where “d” is the total relative displacement and “L” distance between end-winding components. In certain embodiments, the maximum strain (εₘₐₓ) measured by a fiber Bragg grating 54 is about 5000 uε. For end-winding components separated by 50 millimeters (L=50 millimeters), for example, the maximum displacement (dₘₐₓ) that can be measured is 0.25 mm according to equation 3. The embodiments described in FIGS. 8 through 12 increase the maximum displacement measurement range.

With reference to FIG. 8, an embodiment 74 of the measurement portion according to another embodiment comprises two fixation points 63 secured to two connection rings 40 and a sensing cable 50, with one or more Bragg gratings 54, situated between the two fixation points 63. In the illustrated embodiment, the sensing cable 50 is oriented to at an acute angle (θ) with the longitudinal axis (S). In this arrangement, the strain on the fiber Bragg grating sensor (neglecting the small change in angle with displacement) is calculated according to equation 4:

ε(t)≅ cos(θ)d/L equation 4

With a 45-degree angle, 50 mm between end-winding components, and 5000 ue maximum strain on the fiber Bragg grating sensor, the maximum measureable displacement is increased from 0.25 mm to 0.35 mm. Accordingly a larger measurement range (L) can be obtained. Strain on the fiber cause a fiber strain sensor central wavelength shift (Δλ) that may be represented by equation 5:

Δλ≈ξ·K_{ε}·ε(t), equation 5

wherein ξ represents the coupling efficiency of the strain to fiber sensor and is ranging from 0 to 1. K_{ε} represents for fiber sensor strain sensitivity.

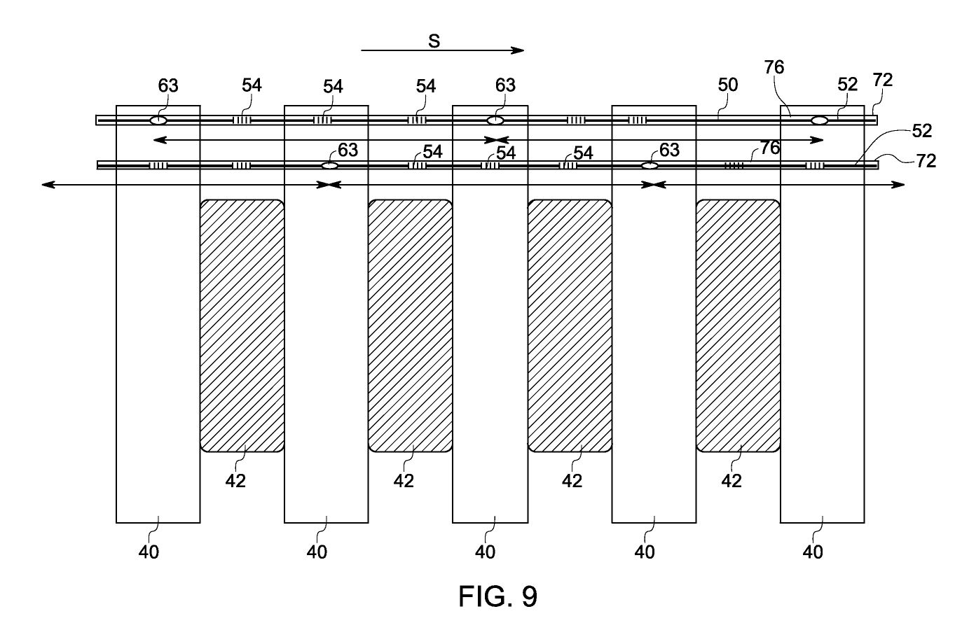

FIG. 9 illustrates that, although fixation points 63 for a given sensing cable 50 may be on adjacent connection rings 40 or may alternatively be on non-adjacent connection rings 40. FIG. 9 additionally illustrates multiple sensing cables 50 being used. In the illustrated embodiment, the two sensing cables 50 are secured at fixation points 63 to every other connection ring 40 in a staggered configuration along the longitudinal axis (S). In this fashion, the distance, L, is doubled, resulting in two times the displacement measurement range. Accordingly, each connection ring 40 is secured with a fixation point 63 and fixation points 63 secured on two neighboring connection rings 40 are on two different measurement portions 76. In one embodiment, the two measurement portions 76 are parallel to each other.

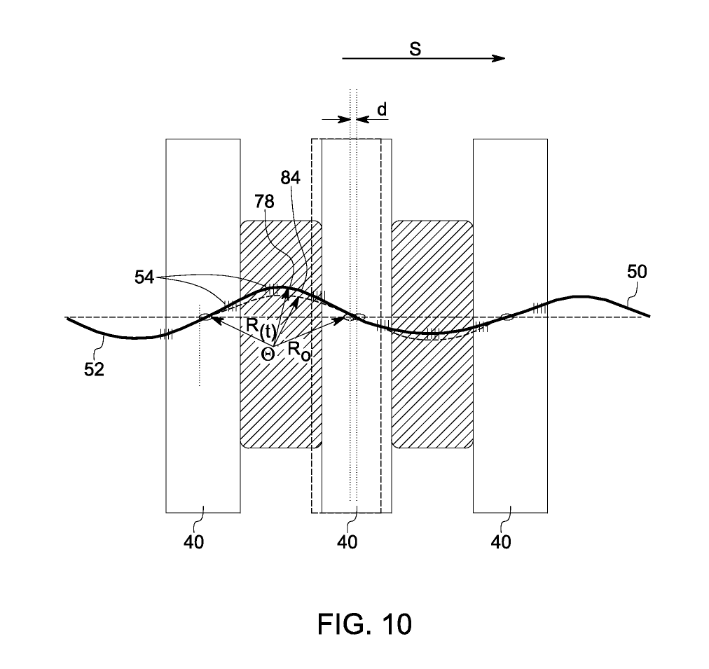

With reference to FIG. 10, according to still another embodiment of the invention, measurement portion 78 comprises a plurality of fixation points 63 secured to connection rings 40, and one or more Bragg gratings 54 inscribed in the optic fiber 52 between every two neighboring fixation points 63. In the illustrated embodiment, the sensing cable has a curved portion 84 between two neighboring fixation portions 63. The curved portion 84 has a radius (R). A relative displacement (d) of two connection rings 40 induces changes to the radius (R). By prior calibration of radius (R) with wavelengths of Bragg gratings 54 between the two connection rings 40, the real-time radius (R) can be obtained by monitoring wavelength shifts of the Bragg gratings 54 for increased displacement measurement range.

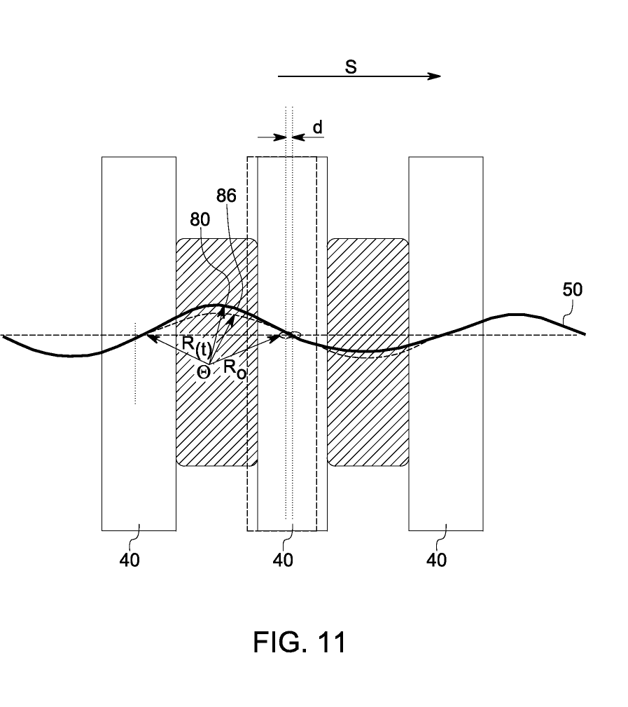

With reference to FIG. 11, according to still another embodiment of the invention, a measurement portion 80 of sensing cable 50 comprises a fiber sensor 86 by measuring bending loss of the optic sensor. A fiber optic cable is bent beyond a predetermined radius the light transmission characteristics of the cable are adversely affected, and these effects are termed “bending losses”. The light directed through a fiber optic cable is normally internally reflected at the core-cladding boundary. When the fiber is bent beyond a critical radius, the light through the cable core strikes the core-cladding boundary at an angle greater than the critical angle, and will not be totally internally reflected, but will be lost through the cladding. In the illustrated embodiment of FIG. 10, measurement portion 80 of sensing cable 50 comprises a plurality of fixation points 63 secured to connection rings 40, and fiber sensor 86 sensitive to bending loss between two neighboring fixation points 63. In one embodiment, fiber sensor 86 is a fiber section comprising either polyimide or composite sheath material. In the illustrated embodiment, fiber section 86 has a curved shape with a radius (R). A relative displacement (d) of two connection rings 40 induces changes to the radius (R). By prior calibration of radius (R) with bending loss of fiber section 86, the real-time radius (R) can be obtained by monitoring bending loss of fiber section 86.

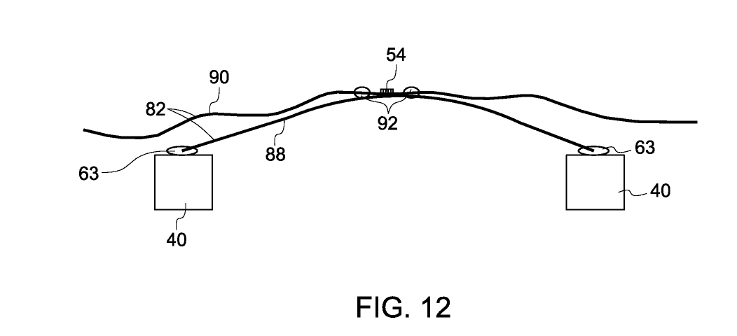

With reference to FIG. 12, according to still another embodiment of the invention, a measurement portion 82 comprises a sensing cable which is a curved semi-rigid tie 88 having fixation points 63 fixed to two connection rings 40 or other end-winding components. The measurement portion 82 further comprises at least one sensor comprising an optical fiber 90 and at least one Bragg grating 54 inscribed in the optical fiber 90 for measuring a deformation of the curved semi-rigid tie 88. In the illustrated embodiment, the curved semi-rigid tie 88 has a curvature that is modulated with the displacement of the end-winding components with the displacement introducing bending strain in the semi-rigid tie. The optical fiber 90 has two securing points 92 fixed to a section of the semi-rigid tie 88 and with the Bragg gratings 54 is between the two securing points 92. The bending strain can be obtained by monitoring wavelength changes of Bragg grating 54.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. The various features described, as well as other known equivalents for each feature, can be mixed and matched by one of ordinary skill in this art to construct additional systems and techniques in accordance with principles of this disclosure.

1. A stator comprising:
stator end-winding components; and
a sensing cable comprising two fixation points secured to two of the end-winding components and sensors to measure a relative displacement between the two of the stator end-winding components.

2. The stator of claim 1, wherein the stator end-winding components comprise end winding bars, end winding loops, interconnection conductors, and a plurality of connection rings.

3. The stator of claim 2, wherein the two fixation points are secured to two of the connection rings and adjacent to at least one of the interconnection conductors.

4. The stator of claim 1, wherein the sensors comprise fiber material sensitive to mechanical strain.

5. The stator of claim 1, wherein the sensors comprise fiber Bragg gratings of at least one modulation period.

6. The stator of claim 1, wherein the sensing cable comprises an optical fiber including fiber sensors, a sheath tube, and an adhesive material between the optical fiber and the sheath tube.

7. The stator of claim 1, wherein the sensing cable comprises a supporting tube and an optical fiber coated with a polymeric layer, and wherein the optical fiber is secured to an outer surface of the supporting tube.

8. The stator of claim 2, wherein the sensing cable is substantially perpendicular to the two end-winding components or at an acute angle with the two end-winding components.

9. The stator of claim 2, wherein the sensing cable comprises a curved shape between the two end-winding components.

10. The stator of claim 3, wherein at least some of the sensors are secured between adjacent connection rings.

11. The stator of claim 3, wherein at least some of the sensors are secured between non-adjacent connection rings.

12. The stator of claim 3, wherein at least some of the sensors are secured at different positions along a perimeter of the connections rings.

13. The stator of claim 2, wherein the sensing cable comprises at least two sensing cables and wherein fixation points securing the at least two fiber optic sensing cables are staggered.

14. A stator end-winding component monitoring system comprising:
a fiber optic sensing cable comprising sensors each secured by fixation points between two stator end-winding components;
a light source for supplying light to the sensors;
a light detector for receiving light that has passed through or has reflected from the sensors; and
a processor for receiving signals indicative of the detected light from the light detector and for using the signals for determining whether a relative displacement between any two of the end-winding components is outside an acceptable range.

15. The system of claim 14, wherein the stator end-winding components comprise end winding bars, end winding loops, interconnection conductors, and a plurality of connection ring.

16. The system of claim 14, wherein the sensors comprise fiber Bragg gratings of at least one modulation period.

17. The system of claim 15, wherein the sensing cable portion extending between the two end-winding components is substantially perpendicular to the two of the end-winding components or at an acute angle with a longitudinal axis of the stator.

18. The system of claim 15, wherein at least some of the sensors are secured between adjacent end-winding components.

19. The system of claim 15, wherein at least some of the sensors are secured between non-adjacent end-winding components.

20. The system of claim 15, wherein the sensing cable comprises at least two sensing cables and wherein fixation points securing the at least two fiber optic sensing cables are staggered.
